(19) United States
(12) Patent Application Publication
(10) Pub. No.: US 2020/0373048 A1
(43) Pub. Date: Nov. 26, 2020

(54) POWER TRANSMISSION APPARATUS AND METHODS

(71) Applicant: Techwell (HK) Limited, Hong Kong (HK)

(72) Inventor: Ka Wai Eric Cheng, Hong Kong (HK)

(21) Appl. No.: 16/969,188

(22) PCT Filed: Feb. 12, 2019
(86) PCT No.: PCT/IB2019/051095

§ 371 Date: Aug. 11, 2020

(30) Foreign Application Priority Data
Feb. 12, 2018 (HK) 18102247.7

(51) Int. Cl. H01F 3/10

(52) U.S. Cl. CPC H01F 3/10

(57) ABSTRACT

A power transmission apparatus comprising a primary magnetic circuit, a primary excitation circuit for connection to an alternating power source to supply input power to the primary magnetic circuit, and a secondary magnetic circuit for supplying output power to a load is disclosed. The power transmission apparatus facilitates wireless power transfer (WPT). The primary magnetic circuit In and the secondary magnetic circuit are detachably attached and cooperate to form a looped output magnetic circuit defining a looped output magnetic path along which an output power carrying magnetic flux flows. The primary magnetic circuit and the secondary magnetic circuit are detachably attached by a magnetic attraction force due to flowing of the output power carrying magnetic flux between the primary magnetic circuit and the secondary magnetic circuit during power transmission operations.

### FIELD

The present disclosure relates to electrical power transmissions, and more particularly to apparatus and methods for electrical power transmissions.

### BACKGROUND

Electrical power is almost indispensable in modern life.

Safe, efficient and flexible power transmissions are desirable and advantageous.

### DISCLOSURE

A power transmission apparatus comprising a primary magnetic circuit, a primary excitation circuit for connection to an alternating power source to supply input power to the primary magnetic circuit, and a secondary magnetic circuit for supplying output power to a load is disclosed. The power transmission apparatus facilitates wireless power transfer (WPT).

The primary magnetic circuit and the secondary magnetic circuit are detachably attached and cooperate to form a looped output magnetic circuit defining a looped output magnetic path along which an output power carrying magnetic flux flows. The primary magnetic circuit and the secondary magnetic circuit are detachably attached by a magnetic attraction force due to flowing of the output power carrying magnetic flux between the primary magnetic circuit and the secondary magnetic circuit during power transmission operations.

The primary magnetic circuit may comprise a looped input magnetic circuit defining a looped input magnetic path and the looped input magnetic path is confined within the looped input magnetic circuit of the primary magnetic circuit, wherein an open-circuit magnetic flux is to flow along the looped input magnetic path in response to flow of input alternating current through the primary excitation circuit when the secondary magnetic circuit is physically detached and/or magnetically detached from the primary magnetic circuit so that no effective output power carrying magnetic flux flows into the secondary magnetic circuit.

The primary magnetic circuit may comprise an exterior peripheral surface which extends along the looped input magnetic circuit and surrounds the looped input magnetic path; and wherein the secondary magnetic circuit is detachably attached to the exterior peripheral surface during power transmission operations when the output power carrying magnetic flux flows from the primary magnetic circuit to the secondary magnetic circuit through the exterior peripheral surface.

The primary magnetic circuit may comprise a plurality of high permeability circuit portions and adjacent high permeability circuit portions are separated by and/or connected in series with one low permeability circuit portion or a plurality of low permeability circuit portions, wherein the low permeability circuit portions are connected in series with one high permeability circuit portion or a plurality of hybrid circuit portions comprising alternately connected low and high permeability circuit portions; wherein the primary magnetic circuit comprises a plurality of flux coupling portions for facilitating coupling of magnetic flux between the primary magnetic circuit and the secondary magnetic circuit and the plurality of flux coupling portions are on a corresponding plurality of the high permeability circuit portions.

The plurality of flux coupling portions may be on the exterior peripheral surface of the high permeability circuit portions. Power carrying magnetic flux moves from the primary magnetic circuit to the secondary magnetic circuit through the flux coupling portions to facilitate wireless power transfer to a load connected to the secondary magnetic circuit. Therefore, the flux coupling portion is a flux passage portion and has a flux passage surface through which the power carrying flux moves between the primary magnetic circuit and the secondary magnetic circuit.

The secondary magnetic circuit may be detachably attached to the primary magnetic at a plurality of flux coupling portions on the primary magnetic circuit, wherein the primary magnetic circuit has a first permeability across the plurality of flux coupling portions and the secondary magnetic circuit has a plurality of flux tapping portions and a second permeability across the plurality of flux tapping portions, and wherein the second permeability is comparable or higher than the first permeability.

A power transmission apparatus comprising a primary magnetic circuit and an excitation circuit which is adapted for transmission of electrical power from the primary magnetic circuit to a load which is connected to a secondary magnetic circuit is disclosed.

The primary magnetic circuit comprises a looped magnetic circuit defining a first looped path and the excitation circuit comprises a power input for connection to an alternating current source.

The excitation circuit is to generate a primary magnetic flux of an alternating magnetic field when alternating current flows through the excitation circuit and the magnetic flux is to flow along the first looped path which is confined within the primary magnetic circuit and which defines a non-load flux path and a non-load flux direction when the primary magnetic circuit is under a no-load condition when the primary magnetic circuit is not in effective magnetic field communication with a loaded secondary magnetic circuit.

The primary magnetic circuit comprises a plurality of flux coupling portions through which a secondary magnetic flux carrying energy to be transferred to the load is to flow into and out of a secondary magnetic circuit from the primary magnetic circuit when the secondary magnetic circuit is in effective magnetic field communication with the primary magnetic circuit and when alternating current flows through the excitation circuit.

The flux coupling portion comprises a flux passage surface through which the secondary magnetic flux is to flow and the flux passage surface is outside the first looped path and/or wherein the secondary magnetic flux is to flow in a shunting path which bypasses a shunted portion of the first looped path, and the shunting path is outside the first looped path and outside the looped magnetic circuit.

The flux passage surfaces of the plurality of flux coupling portion of the primary magnetic circuit may be coplanar.

In some embodiments, the flux passage surfaces of the plurality of flux coupling portion of the primary magnetic circuit may be covered by, underneath or behind a non-magnetic covering surface for cosmetic or decorative purposes.

A high permeability circuit portion of a looped primary magnetic circuit may have a relative permeability of 10 times or more of the low permeability circuit portion. In some embodiments, the ratio between the relative permeability may be between 50 to 100 or more.

In some embodiments, the high permeability circuit portion may have a relative permeability μ_{R} or more than 2000, for example, a relative permeability of between 2000 to 4000. A high permeability magnetic circuit portion may be formed by doping a non-magnetic filler with ferrites or iron powder.

### FIGURES

The present disclosure will be described by way of example with reference to the accompanying figures, in which:

FIG. 1A is a schematic diagram of an example primary magnetic circuit according to the disclosure,

FIG. 1A1 is a schematic equivalent circuit of the example primary magnetic circuit of FIG. 1A,

FIG. 1A2 is a schematic voltage current diagram of the source,

FIG. 2A is a schematic diagram of an example power transmission apparatus 10 comprising the example primary magnetic circuit of FIG. 1A,

FIG. 2A1 is a schematic equivalent circuit of the example power transmission apparatus of FIG. 2A,

FIG. 2B is a schematic diagram of an example power transmission apparatus 20 comprising the example primary magnetic circuit of FIG. 1A,

FIG. 2C is a schematic diagram of an example power transmission apparatus 30 comprising the example primary magnetic circuit of FIG. 1A,

FIG. 2D is a schematic diagram of an example power transmission apparatus 40, FIG. 2E is a schematic diagram of an example power transmission apparatus 50,

FIG. 2F is a schematic diagram of an example power transmission apparatus 60,

FIG. 3 is a graph showing relationship between power coupling coefficients and relative permeability of a power transmission apparatus,

FIGS. 4A to 4E are schematic diagrams of example power transmission apparatus according to the present disclosure,

FIG. 5A is a schematic diagram of an example power transmission apparatus 80, and

FIGS. 5A1 and 5A2 schematic plan and side elevation views of the power transmission apparatus of FIG. 5A.

### DESCRIPTION

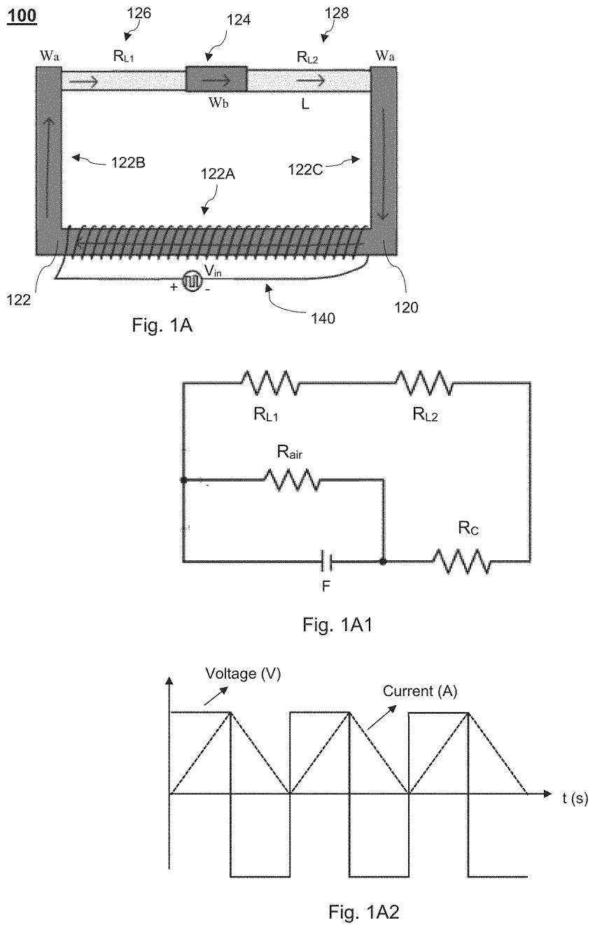

An example power input apparatus 100 of a power transmission apparatus comprises an example primary magnetic circuit 120 and an example primary excitation circuit 140 which is magnetically coupled with the primary magnetic circuit 120, as depicted in FIG. 1A. The power transmission apparatus comprises a power input apparatus 100 and a power output apparatus which is for connection to a load and electrical power is transferrable from the power input apparatus to load via the power output apparatus when alternating electrical power is supplied to the power input apparatus 100 during power transmission operations. The primary excitation circuit 140 is for connection to an alternating power source to obtain power for operation of the power transmission apparatus as well as power for transfer to a load which is connected a power output apparatus. The power for operation of the power transmission apparatus includes power for operation of the power input apparatus 100 and power for operation of the power output apparatus. The primary magnetic circuit comprises a looped magnetic circuit which defines a looped magnetic flux path which is confined within the primary magnetic circuit. During stand-alone operations of the power input apparatus 100 when no output apparatus is effectively connected to the power input apparatus 100, magnetic flux generated by excitation power which is supplied by the primary excitation circuit 140 of the power input apparatus 100 is effectively confined within the primary magnetic circuit and will flow along the looped magnetic flux path.

The example primary magnetic circuit 120 comprises a C-shaped magnetic core portion 122 and a linear core portion which are assembled to form the primary magnetic circuit.

The C-shaped core portion 122 comprises an elongate base portion 122A which extends between two opposite longitudinal ends and two limb portions 122B, 122C of equal or substantially equal lengths which extend orthogonally from the longitudinal ends of the elongate base portion 122A to form the C-shaped core portion 122 and a C-shaped internal compartment. The two limb portions 122B, 122C which are at the opposite longitudinal ends of the elongate base portion 122A are substantially parallel and are separated by a distance which is substantially equal to the length of the elongate base portion 122A minus the widths of the two limb portions 122B, 122C. The C-shaped core portion 122 has an interior facing peripheral surface which extends along the length of the C-shaped core portion 122 to define an outer boundary of the C-shaped internal compartment and an exterior facing peripheral surface which extends along the length of the C-shaped core portion 122 to define an outer boundary of the C-shaped core portion 122. The C-shaped core portion has an opened mouth portion which is defined between the free ends of the two limb portions 122B, 122C and which defines a first partial looped magnetic circuit portion. The word “elongate” is to assist the illustration of the diagram. The actual size can be short.

The linear core portion is an elongate assembly extending along a longitudinal axis and having a pair of end surfaces at its opposite longitudinal ends. The linear core portion is connected to the open ends of the C-shaped core portion 122 to close the opened mouth portion and to form a D-shaped primary magnetic circuit which defines a D-shaped looped magnetic circuit and a D-shaped internal compartment. The linear core portion is connected to the C-shaped core portion 122, with the longitudinal end surfaces of the linear portion juxtaposing the interior peripheral surface of the C-shaped core portion at or near the open ends of the C-shaped core portion. The term “connect” and other forms of connect herein means magnetically connect unless the context requires otherwise. The linear core portion comprises an outer peripheral surface which extends along the longitudinal axis of the linear core portion. The outer peripheral surface comprises an interior facing peripheral surface which cooperates with the interior facing peripheral surface of the C-shaped core portion to define an outer boundary of the D-shaped compartment of the D-shaped primary magnetic circuit. The word “linear” is used to illustrate the diagram, the actual shape can be other geometry provided the shape can connect physically, for example, curved.

The linear core portion comprises a first I-shaped core portion 126, a second I-shaped core portion 128 and an intermediate I-shaped core portion 124 which interconnects the first I-shaped core portion 126 and the second I-shaped core portion 128 to form a linear closing core portion. Each of the intermediate I-shaped core portion 124, the first I-shaped core portion 126, and the second I-shaped core portion 128 is an elongate bar of magnetic materials having a longitudinal axis comprising a first longitudinal end, a second longitudinal end, first end surface at the first longitudinal end, second end surface at the second longitudinal end, and a peripheral surface interconnecting the first longitudinal end face and the second longitudinal end surface.

The linear core portion defines a second partial looped magnetic circuit portion. The first partial looped magnetic circuit portion defined by the C-shaped core portion and the second partial looped magnetic circuit portion defined by the linear core portion are magnetically connected to form a looped magnetic circuit of the primary magnetic circuit 120. The primary magnetic circuit 120 is also referred to as a looped input magnetic circuit since it is on the input side of the power transmission apparatus.

The example first partial looped magnetic circuit portion 122 is generally conveniently described as having a “C”-shape herein to represent a magnetic core portion having an opened mouth portion. However, it should be understood that the “C-shaped” core portion does not follow or does not need to follow the strict shape of the curved capital letter C without loss of generality. Likewise, the D-shaped primary circuit has a substantially rectangular shape and does not follow or does not need to follow the strict curved shape of the capital letter D.

The magnetic core portions can be made up of one or more magnetic materials, such as ferrite, a magnetic composite, powdered iron or a material exhibiting magnet properties. Each of the core portions can be additionally encapsulated by protection materials, such as an insulating film for preventing an individual core portion, which may be electrically conductive, from accidentally contacting a power source.

The primary magnetic circuit of this example defines a looped magnetic flux path which is confined with the primary magnetic circuit. During power transmission operations, an excitation current which flows into the primary excitation circuit will generate an operational magnetizing flux which circulates along the looped magnetic flux path. In this example, the D-shaped magnetic circuit defines a D-shaped compartment of empty space of air. In some embodiments, the primary magnetic circuit may be formed into other looped shapes defining multiple internal compartments of empty space of air, may comprise multiple magnetic circuit loops (serially and/or parallelly connected) which define multiple magnetic looped paths without loss of generality.

The primary magnetic circuit 120 comprises a high permeability circuit portion and a low permeability circuit portion which are connected in series to form a closed magnetic circuit loop of a D-shape or a substantially rectangular shape.

The high permeability circuit portion comprises the high permeability C-shaped core portion 122 and the high permeability I-shaped connection portion 124 (or intermediate I-shaped core portion). The high permeability C-shaped core portion 122 and the high permeability I-shaped connection portion 124 are formed of a high magnetic permeability material having a high relative permeability. The low permeability circuit portion comprises two I-shaped bridging portions 126, 128 (or first and second I-shaped core portion 126, 128) which are interconnected by the I-shaped connection portion 124. Each of the I-shaped bridging portions 126, 128 is formed of a low magnetic permeability material which has a substantially lower magnetic permeability than the high magnetic permeability material.

The linear core portion is parallel to and displaced from the elongate base portion 122A by a distance determined by the effective length of the pair of orthogonally extending limbs122B, 122C. The C-shaped magnetic core portion 122 and the linear core portion, which is formed by the low permeability I-shaped bridging portions 126, 128 and the high permeability I-shaped connection portion 124 in series, cooperate to define the skeleton of a looped magnetic circuit of the primary magnetic circuit on an empty space background. The looped magnetic circuit defines a looped magnetic path along which magnetic flux circulates during operations.

The C-shaped magnetic core portion 122 and the linear core branch cooperate to form a primary magnetic circuit which is a looped input magnetic circuit. The looped input magnetic circuit defines a looped flux path along which magnetic flux will flow in response to flow of an excitation current in the primary excitation circuit with the primary magnetic circuit is under no load conditions.

The example magnetic core portion 120 is a 3-dimensional assembly and each of the elongate components has a substantially uniform cross-section, so that the magnetic core portion 120 has a substantially uniform cross-section along the length of the loop. Each of the elongate parts of the magnetic core portion 120 contributes to defining a magnetic flux flow path and can be considered as a magnetic path defining element.

The example excitation circuit 140 comprises a power input and a plurality of excitation windings 142 which is distributedly wound about the elongate base portion 122A. The power input is for connecting the excitation windings to an alternating current (AC) power source and alternating current will flow through the excitation windings when the power input is connected to an alternating power source. When alternating current flows into the excitation circuit 140 during power transfer operations, an alternating magnetic field due to a magnetomotive force F will be generated and the generated magnetic field will move along the magnetic path as defined by the magnetic core portion 120.

An equivalent circuit of the example primary magnetic circuit is depicted in FIG. 1A1. The primary magnetic circuit of FIG. 1A1 comprises a core reluctance R_{C} and a link reluctance R_{L} which are magnetically connected in series. The series connected R_{C} and R_{L} are connected in series with a magnetic power source having a magnetomotive force F and an air reluctance Rₐᵢᵣ is connected in parallel across the magnetic power source. The air reluctance Rₐᵢᵣ in this example is a leakage reluctance which is very high and negligible since the permeability of the components of the magnetic circuit is substantially higher than the permeability of air. For example, low permeability circuit portion has a relative permeability of say 5 to 200 times or up to 500 times that of air, and the high permeability circuit portion has a higher relative permeability of say 400 to 5000 times that of air. For example, the permeability of the high permeability circuit portion is say at least 10 times of the permeability of the lower permeability circuit portion, and can for example be between 10 to 100 or 200 times higher than the permeability of the lower permeability circuit portion. The circuit portion which define the magnetic circuit may be formed of metal or magnetic polymers. Magnetic polymers are advantageous due to their lighter weight and being moldable. Example magnetic polymers may be formed by doping of polymers with organometallic dopants.

In the example magnetic circuit of FIGS. 1A and 1A1, the core reluctance R_{c} is the total series reluctance of the high permeability C-shaped core portion 122 (or C-core portion in short) and the high permeability I-shaped connection portion 124. The link reluctance R_{L} is the total series reluctance of the two I-shaped low permeability bridging portions 126, 128. In this example, each of the two I-shaped low permeability bridging portions 126, 128 is an I-core having a length L, each of the two limb portions 122B, 122C of the C-core portion has a height of H, and the I-shaped connection portion 124 has a width of W_{b}. The width W_{b} of the I-shaped connection portion 124 contributes to the length of the magnetic circuit of FIG. 1A.

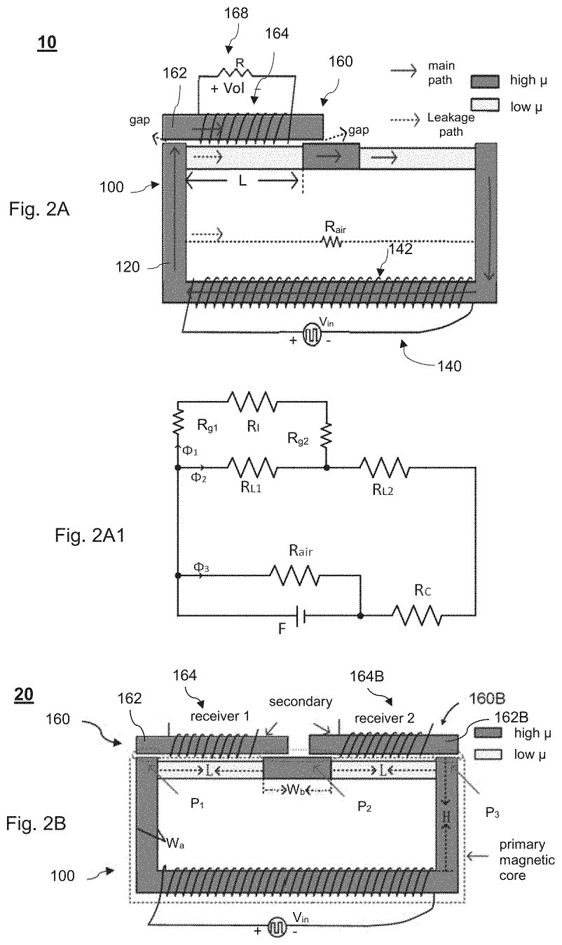

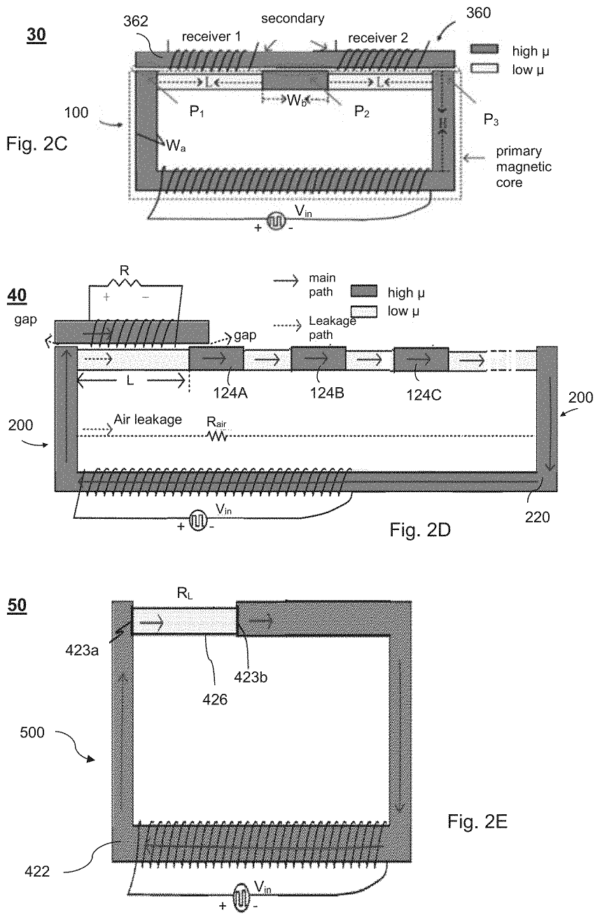

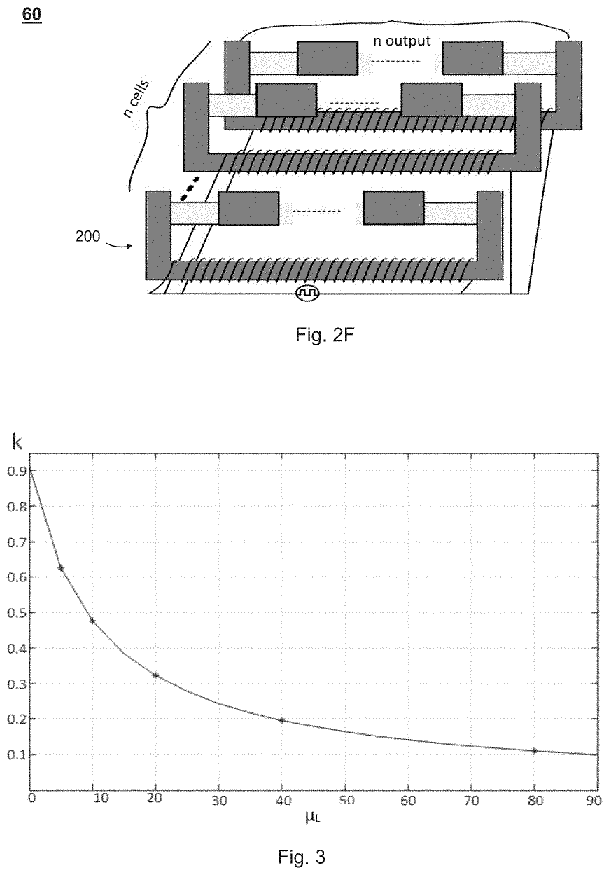

In some embodiments, the C-shaped core portion 122 is integrally formed as a single piece. In some embodiments, the C-shaped core portion 122 is constructed from a plurality of identical elongate I-shaped connection portions. In some embodiments such as the example of FIGS. 1A, 2A and 2B, the example I-shaped connection portion has a polygonal cross-section and a plurality of outward facing side or peripheral surfaces extending between two opposite facing longitudinal end surfaces. Each of the elongate members of the magnetic circuit, for example, the elongate base portion 122A and the elongate limb portion 122B, 122C, may be formed integrally as a single piece or may be constructed from modular components. The modular component may have a standard shape and standard dimensions to facilitate flexible modular construction without loss of generality. The components may be joined by polymer based magnetic glue, by fusion connection or other joining means.

According to Ampere's circuital law, F [symbol] =H·dl=μ₀∫∫J·ds=NI, where F is the magnetomotive force around a closed loop of the magnetic circuit, H is magnetic field in ampere/meter, l is length of the magnetic circuit, μ₀ is the permeability of free space, J is the current density of the excitation current, S is the area of the excitation current in the circuit, N is the number of turns of the excitation winding, and I is the excitation current.

The magnetomotive force F of a magnetic circuit having n magnetic sections or portions in series is equal to ØR or

$${\sum }_{i = 1}^{n} \frac{∅ {l}_{i}}{{A}_{i} {μ}_{o} {μ}_{i}} ,$$

where R is the total reluctance of the magnetic circuit, n is the number of magnetic sections in the closed loop, Ø is the magnetic flux of the magnetic circuit in weber, lᵢ is the length of the magnetic section in meter, Aᵢ is the cross sectional area of the i^{th} magnetic section or portion, μ=μ₀μᵢ is the magnetic permeability of the material, and μᵢ is the relative permeability of the material.

An example power transmission apparatus 10 comprising a power input apparatus and a power output apparatus which is magnetically coupled to the power input apparatus is depicted schematically in FIG. 2A. The example power input apparatus 100 comprises an example primary magnetic circuit 120 and an example primary excitation circuit 140 which is magnetically coupled with the primary magnetic circuit 120, as depicted in FIG. 1A. The example power output apparatus comprises an example secondary magnetic circuit 160 and a group of secondary windings 164 which is magnetically coupled with the secondary magnetic circuit 160, as depicted in FIG. 2A. The example power output apparatus is detachably attached to the primary magnetic circuit 120 and is to tap electrical power from the primary magnetic circuit for supply to an electrical load connected to the secondary magnetic circuit 160 when so attached during power transmission operations when an alternating input power is supplied to the power input apparatus 100.

The assembly of the example secondary magnetic circuit 160 and the secondary windings 164 is conveniently referred to as a ‘power tapping device’ or a ‘power tapping arrangement’ herein due to its ability to tap power from the primary magnetic circuit 120 by detachable attachment.

The example power tapping device comprises an elongate body 162 of a high magnetic permeability on which a plurality of secondary windings 164 is wound. The elongate body 162 and the secondary windings 164 cooperate to form a high permeability magnetic circuit portion. The elongate body 162 is to function as a power tapping body and extends along a longitudinal axis. The elongate body 162 comprises a first longitudinal end, a first end surface on the first longitudinal end which end surface extends transversely to the longitudinal axis, a second longitudinal end, a second end surface on the second longitudinal end which end surface extends transversely to the longitudinal axis, and an exterior peripheral surface interconnecting the first end surface and the second ends surface and extending along the longitudinal axis.

The secondary windings 164 are wound between the first and second longitudinal ends of the elongate body 162, leaving the longitudinal ends of the elongate body unwound, naked and magnetically unshielded to serve or function as flux coupling portions to facilitate flux coupling from the primary magnetic circuit 120. The magnetic flux which is to be coupled from the primary magnetic circuit to the secondary magnetic circuit is power carrying flux. Electrical and magnetic power is coupled from the primary magnetic circuit to the secondary magnetic circuit through movement of the power carrying flux through the flux coupling portions. Therefore, a flux coupling portion is also referred to as a power coupling portion herein.

In some embodiments, the high permeability circuit portions of the primary magnetic circuit and the secondary magnetic circuit are formed of the same magnetic material, have the same permeability, and have the same cross-sectional area to promote uniformity of the magnetic circuit.

In this example, the elongate body of the secondary magnetic circuit is an elongate bar formed of the same material as the I-shaped connection portion 124 and has the same permeability and the same cross-sectional shape and area as a convenient example. In this example, the elongate bar is to function as a power tapping bar and the power tapping bar is an elongated version of the I-shaped connection portion 124. Optionally and advantageously, the power tapping bar has a substantially higher permeability than the permeability of the shunted portion of the primary magnetic circuit from which power is to be tapped. In some embodiments, the power tapping bar may have a permeability which is different to that of the high permeability circuit portions of the primary magnetic circuit without loss of generality.

Referring to FIG. 2A, the secondary magnetic circuit 160 is detachably attached to the primary magnetic circuit to facilitate magnetic power coupling between the secondary magnetic circuit and the primary magnetic circuit. When the secondary magnetic circuit 160 is detachably attached to the primary magnetic circuit, a first flux coupling portion on a longitudinal end of the outer peripheral surface of the elongate body 162 is in abutment contact with the free end on the first limb portion 122B of the primary magnetic circuit 120 and a second flux coupling portion on the other longitudinal end of the outer peripheral surface of the elongate body 162 is in abutment contact with an outer peripheral surface of the I-shaped connection portion 124 of the primary magnetic circuit 120. In the example, the elongate body 162 has a length that is longer than the length of the I-shaped low permeability portion 126 so that the elongate body 162 can form a bridging portion which is detachably attached to two adjacent high permeability portions on the primary magnetic circuit which are connected to and separated by a lower permeability portion, which is the I-shaped low permeability portion 126 in this example. When the elongate body 162 is attached to the two adjacent higher permeability portions, the bridging portion formed by the elongate body 162 spans across the lower permeability portion and provides a bypassing path to the lower permeability portion. When the elongate body 162 has a substantially higher permeability than the lower permeability portion, a substantial portion of the magnetic flux generated in the primary magnetic circuit would be shunted from the lower permeability portion and flow through the elongate body 162 bridging portion.

When the secondary magnetic circuit 160 is magnetically coupled to the primary magnetic circuit 120 following the detachable attachment, a magnetic shunt branch having a substantially lower magnetic reluctance in parallel with the bridging portion 126 having a substantially higher magnetic reluctance is formed. As this newly formed shunt branch has a magnetic reluctance which is substantially lower than the magnetic reluctance of the bridging portion 126, a substantial portion of the magnetic field, which was previously confined within the magnetic circuit of the primary circuit before the attachment or before the magnetic coupling when the primary magnetic circuit 120 is under AC excitation, is now diverted into the shunt branch and into the secondary magnetic circuit 160. When an electrical load is connected to the secondary windings 164 of the secondary magnetic circuit 160, electrical power will be delivered to the load from the primary magnetic circuit via the second magnetic circuit.

Referring to the equivalent magnetic circuit of the power transmission apparatus 10 as depicted in FIG. 2A1, the secondary magnetic circuit comprises a magnetic shunt branch having a reluctance of Rₛ which is connected in parallel with a magnetic branch of the first bridging portion 126 having a reluctance of R_{L1}. The reluctance of Rₛ of the magnetic shunt branch 162 consists of a series connection of a first airgap reluctance R_{g1}, a reluctance Rₗ of the power tapping bar and second airgap reluctance R_{g2}. As the reluctance of Rₛ is substantially lower than the reluctance R_{L1,} for example, less than 5%-10%, a substantial portion (for example, more than 90% or 95%) of the total magnetic flux Øₜ=Ø₁+Ø₂ in the shunt-branch that will be diverted into the shunt branch to facilitate power transfer.

When the secondary magnetic circuit 160 and the primary magnetic circuit 120 are magnetic coupled and in magnetic field communication, the magnetic coupling force between the secondary magnetic circuit and the primary magnetic circuit will operate to attract and maintain the secondary magnetic circuit in a fixed relative position with respect to the primary magnetic circuit. As a result of the fixed relative position between the secondary magnetic circuit and the primary magnetic circuit, the degree and extent of magnetic coupling and power transfer between the secondary magnetic circuit and the primary magnetic circuit will remain constant during normal power transfer operations.

To facilitate more flexible and effective magnetic coupling and power transfer to the secondary side, a plurality of power output portions is formed on the high permeability circuit portion of the primary magnetic circuit. The power output portion is optionally a magnetically unshielded portion to mitigate magnetic reluctance in the magnetic coupling path due to shielding materials. A power output portion is also referred to as a power tapping portion herein. The power output portion is also referred to as a flux coupling portion or a flux passage portion herein as magnetic flux generated by the flow of excitation current in the primary excitation circuit is to transit through the power output portion during power transfer operations between the primary magnetic circuit and the secondary magnetic circuit. A magnetically unshielded portion herein is also referred to as a magnetically naked surface or a magnetically exposed surface herein. In the example of FIGS. 1A and 2A, the high permeability circuit portion of the primary magnetic circuit are magnetically unshielded along a substantial length portion to facilitate flexible selection and convenient location of power output portions by a user.

To facilitate more effective or more efficient power transfer and magnetic coupling with the primary side, the secondary magnetic circuit comprises magnetically unshielded portions to serve or operate as power input portions or power coupling portions. A power input portion or a power coupling portion of the secondary magnetic circuit herein is also a flux coupling portion, and is referred to as such for ease of reference. In the example of FIG. 2A, the entire power tapping bar is magnetically unshielded so that power output portions comprising power output surfaces are distributed along the entire high permeability circuit portion.

Referring to FIG. 2A, the power tapping bar 162 of the secondary magnetic circuit is detachably attached to the power output portions of the primary magnetic circuit to facilitate power transfer. In this example, the power output portions of the primary magnetic circuit comprise a first power output portion and a second power output portion. The first power output portion comprises a first power output surface which is an end surface on a free longitudinal end of the first limb portion 122B. The second power output portion includes a second power output surface which is on an outward facing peripheral surface of the I-shaped connection portion 124 which is proximal the low permeability I-shaped bridging portions 126. When the power tapping bar of the secondary magnetic circuit is detachably attached to the power output portions of the primary magnetic circuit, an exposed side or peripheral surface at a first longitudinal end of the power tapping bar is in abutment with the end surface of the first limb portion 122B and another exposed side or peripheral surface at a second longitudinal end of the power tapping bar distal to the first longitudinal end is in abutment with outward facing peripheral surface of the I-shaped connection portion 124 which is proximal the low permeability first I-shaped bridging portion 126. When the power tapping bar of the secondary magnetic circuit is detachably attached to the power output portions of the primary magnetic circuit of FIG. 2A, the power tapping bar is physically displaced from the I-shaped bridging portions 126 and a substantial portion of the magnetic field is diverted into a path which is displaced from the original path defined by the first I-shaped bridging portion 126.

The total magnetic reluctance of the magnetic circuit loop of the power transmission apparatus 10 is equal to R_{μ}_{_{L}}+R_{μ}_{_{H}}, where R_{μ}_{_{L}} is the total reluctance of the low permeability magnetic circuit portions and R_{μ}_{_{H}} is the total reluctance of the high permeability magnetic circuit portions. In the example of FIG. 2A, R_{μ}_{_{H}}=Rₛ+R_{C}, where Rₛ is the reluctance of the shunt branch and equals Rₗ+R_{g1}+R_{g2}, R_{g1}=R_{g2}=R_{g} is the airgap reluctance which is assumed equal on both ends of the power tapping bar, and

$${R}_{g} = \frac{{l}_{g}}{{A}_{e} {μ}_{0}} ,$$

where l_{g} is the airgap width, μ₀ is the permeability of air, R_{C} is the reluctance of the C-shaped core portion and equals

$${R}_{C} = \frac{2 L + 2 H + {w}_{a} + {w}_{b}}{{μ}_{H} {A}_{e} {μ}_{0}} ,$$

μ_{H} is the relative permeability of the high permeability material, Rₗ is the reluctance of the power tapping bar equal and

$${R}_{{μ}_{L}} = \frac{L}{{μ}_{L} {A}_{e} {μ}_{0}} ,$$

where μ_{L} is the relative permeability of the low permeability material and Aₑ is the cross-sectional area of the magnetic circuit which is uniform in this example. Where the primary magnetic circuit is concealed under a surface, for example a cosmetic surface such as a wall or a partition, l_{g} would become the thickness of the wall or the partition and μ₀ would become the permeability of the wall or the partition.

The portion of the magnetic flux Ø₁ that is coupled to the secondary magnetic circuit relative to the total magnetic flux Ø_{T} is represented by a power coupling coefficient, k=Ø₁/Ø_{T}, where Ø_{T}=Ø₁+Ø₂+Ø₃ in the example of FIG. 2A1 is the total magnetic flux due to magnetomotive force F, Ø₂ is the magnetic flux in the first I-shaped bridging portions 126 and Ø₃ is the magnetic flux in the airpath of the primary magnetic circuit.

In the example of FIG. 2A,

$${∅}_{1} = \frac{F}{[ ( 2 {R}_{g} + {R}_{I} ) // {R}_{L 1} + {R}_{L 2} + {R}_{C} ]} \times \frac{( {R}_{I} + 2 {R}_{g} ) // {R}_{L 1}}{( {R}_{I} + 2 {R}_{g} )} = \frac{F}{{R}_{air}} , and$$

$${∅}_{2} = \frac{F}{[ ( 2 {R}_{g} + {R}_{I} ) // {R}_{L 1} + {R}_{L 2} + {R}_{C} ]} \times \frac{( {R}_{I} + 2 {R}_{g} ) // {R}_{L 1}}{{R}_{L 1}} .$$

Where R_{I} and R_{C} can be neglected and R_{L1}=R_{L2}=R_{μL}, the power coupling coefficient

$$k = \frac{1}{1 + \frac{2 {R}_{g}}{{R}_{{μ}_{L}}} + \frac{4 {R}_{g}}{{R}_{air}} + \frac{{R}_{{μ}_{L}}}{{R}_{air}}} .$$

The relation between the power coupling coefficient k and the low permeability μ_{L} for the example power transmission apparatus 10 of FIG. 2A, where the cross-sectional area is 400 mm², each of the I-shaped bridging portions 126, 128 has a length of 60 mm, the airgap is 3 mm and the leakage loop reluctance Rₐᵢᵣ is regarded as constant at 3×10⁷ A/Wb is shown in FIG. 3. It will be noted that from the graph of FIG. 3 that the power coupling coefficient falls rapidly, and almost exponentially, with increase in μ_{L}.

The magnetic flux received by the power tapping bar is transformed into electric energy by [symbol] E.

$$dl = - \int \frac{\partial B}{\partial t} \cdot dA ,$$

where E is me electric field induced in the secondary magnetic circuit, l is the displacement and A is the area of the magnetic path concerned. The left hand side of the equation gives the voltage induced in the secondary windings 164 wound on the power tapping bar 162, the right hand side of the equation gives the change of magnetic flux. For a high frequency switching, the frequency of the primary current is to provide the rate of change of the flux.

The looped magnetic circuit of the primary magnetic circuit comprises a plurality of high permeability output portions and the output portions are separated by a plurality of low permeability bridging portions. In the example, there are an example of three high permeability output portions which are separated by two low permeability bridging portions. For example, any two of the three or more output portions can be selected to form a pair of flux coupling portions for flux coupling to the secondary magnetic circuit without loss of generality.

An example power transmission apparatus 20 is depicted schematically in FIG. 2B. The example power transmission apparatus 20 comprises a primary magnetic circuit and two secondary magnetic circuits 160, 160B which are detachably attached to the primary magnetic circuit. An example primary magnetic circuit of the example power transmission apparatus 20 is a primary magnetic circuit 120 of FIG. 1A and each of the example secondary magnetic circuits is an example secondary magnetic circuit of FIG. 2A.

Referring to FIG. 2B, the example power transmission apparatus 20 is identical to the example power transmission apparatus 10 of FIG. 2A plus an additional secondary magnetic circuit 160B. The additional secondary magnetic circuit 160B is generally identical to the secondary magnetic circuit 160 and comprises the example power tapping device which comprises an elongate bar 162 of a high magnetic permeability on which a plurality of secondary windings 164 is wound. The elongate bar, which is to function as a power tapping bar, and the secondary windings cooperate to form a high permeability magnetic circuit portion and the longitudinal ends of the elongate bar are unwound and naked or magnetically unshielded to serve or function as power coupling portions to facilitate power coupling from the primary magnetic circuit.

Referring to FIG. 2B, the power tapping bar of the additional secondary magnetic circuit 160B is detachably attached to the power output portions of the primary magnetic circuit to facilitate power transfer. In this example, the power output portions of the primary magnetic circuit comprise a first power output portion and a second power output portion. The first power output portion comprises a first power output surface which is an end surface on the free longitudinal end of the second limb portion 122C. The second power output portion includes a second power output surface which is on an outward facing peripheral surface of the I-shaped connection portion 124 which is proximal the low permeability I-shaped bridging portions 128. When the power tapping bar of the secondary magnetic circuit is detachably attached to the power output portions of the primary magnetic circuit, an exposed side or peripheral surface at a first longitudinal end of the power tapping bar is in abutment with the end surface of the second limb portion 122C and another exposed side or peripheral surface at a second longitudinal end of the power tapping bar distal to the first longitudinal end is in abutment with outward facing peripheral surface of the I-shaped connection portion 124 which is proximal the low permeability first I-shaped bridging portion 128. When the power tapping bar of the secondary magnetic circuit is detachably attached to the power output portions of the primary magnetic circuit of FIG. 2B, the power tapping bar is physically displaced from the I-shaped bridging portions 128 and a substantial portion of the magnetic field is diverted into a path which is displaced from the original path defined by the first I-shaped bridging portion 128.

In this example power transmission apparatus 20, the power coupling coefficients of each of the secondary magnetic circuit are equal and equal to k above.

The electrical power that is transferred to a load which is connected to a power transmission apparatus generally equals the input power to the power transmission apparatus minus the power loss of the power transmission apparatus, that is, Pₒ=Pᵢ−δ, where Pᵢ is the input power, Pₒ is the output or transferred power and δ is the power loss.

For the example power transmission apparatus, the excitation current Iᵢ which flows in the primary magnetic circuit can be expressed by the relationship:

$${I}_{i} = \frac{Bl}{{Nu}_{r} {u}_{0}} ,$$

where B is flux density and l is the length of the magnetic circuit. The excitation current Iᵢ is related to the magnetic flux Ø which flows inside the primary magnetic circuit by the relationship

$$∅ = \frac{{NI}_{i}}{R} = {A}_{e} B ,$$

where Aₑ is the effective cross-sectional area of the magnetic path. The maximum magnetic flux Øₛ without causing saturation of the magnetic circuit corresponds to a maximum flux density Bₛ without causing saturation.

To promote efficient power transfer operations, the primary magnetic circuit is in an unsaturated state such that the magnetic core is not saturated and the maximum power that can be transferred by the power transmission apparatus without saturation of the primary magnetic circuit is dependent on the maximum current without causing magnetic saturation since the magnetic flux is proportional to the current.

The maximum current Iₘₐₓ that can flow within the primary magnetic circuit without causing magnetic saturation can be expressed by the relationship:

$${I}_{max} = \frac{{B}_{s} l}{{Nu}_{r} {u}_{0}} .$$

The primary current Iₚ that flows into the power transmission apparatus and the transferrable current Iₜ that can be transferred out to the secondary side is related by the expression: Iₚ=Iₜ+Iₘ, where Iₘ is the magnetizing current.

Assuming that the magnitude of the magnetizing current is substantially smaller than the magnitude of the transferrable current, for example,

$${i}_{m} \leq \frac{{i}_{t}}{10} ,$$

the maximum input voltage Vₘₐₓ is related to the maximum input current by the relationship:

$${V}_{max} = {L}_{M} \frac{{di}_{{L}_{M}}}{dt} = \frac{{u}_{r} {u}_{0} {A}_{e} {N}^{2}}{l} \frac{2 {I}_{max}}{11 {T}_{s}} , where$$

$${L}_{M} = \frac{{u}_{r} {u}_{0} {A}_{e} {N}^{2}}{l}$$

is the value of magnetizing inductance.

Therefore, the maximum input power Pₘₐₓ can be expressed as:

$${P}_{max} = {V}_{max} {I}_{max} = \frac{{u}_{r} {u}_{0} {A}_{e} {N}^{2}}{l} \frac{2 {I}_{max}}{11 {T}_{s}} {( \frac{{B}_{s} l}{{Nu}_{r} {u}_{0}} )}^{2} = \frac{2 {SB}_{s}^{2} l}{11 {u}_{r} {u}_{0}} {f}_{s} .$$

It will be appreciated from the expression of the maximum input power Pₘₐₓ that a higher input power can be obtained with a higher excitation current frequency and a lower permeability magnetic circuit. However, a higher excitation current frequency also means higher magnetic core losses and a lower permeability also means higher magnetic core losses. Therefore, a balance between excitation current frequency, core permeability and core losses would need to be struck when designing a power transmission apparatus according to the disclosure. In general, the balance can be obtained using computer simulation or like tools.

In example operations, the primary magnetic circuit 120 is connected to an AC power source under no-load conditions. When the primary magnetic circuit 120 is under no load conditions, there is no secondary magnetic circuit which is magnetically connected to the primary magnetic circuit or there is no load connected to the secondary magnetic circuit when the secondary magnetic circuit is magnetically connected to the primary magnetic circuit. When the secondary magnetic circuit is magnetically connected to the primary magnetic circuit, the secondary magnetic circuit is magnetically connected to the primary magnetic circuit as a shunt magnetic path which is in parallel with a magnetic path that forms part of the primary magnetic circuit, and magnetic flux inside the primary magnetic circuit will be diverted to flow into the secondary magnetic circuit. Where the secondary magnetic circuit has a substantially higher permeability than the corresponding shunted portion of the primary magnetic circuit, a substantial portion of the magnetic flux will be diverted to flow into the secondary magnetic circuit through one coupling port (also referred to as an entry port or an entry portion) and then return to the primary magnetic circuit through another coupling port (also referred to as an exit port or an exit portion).

When under no-load conditions, for example the no-load condition of FIG. 1A, the primary magnetic circuit is a single-looped magnetic circuit and a single-looped magnetic flux path formed by serial connection of the C-core portion and the linear core branch. When an excitation current is supplied under the no-load condition, the primary magnetic circuit is a highly inductive circuit, a no-load current I₀ which is a magnetizing current Iₘ will flow through the excitation windings to generate a no-load magnetic flux Ø₀ having a no-load magnetic flux density B₀ of an alternating magnetic field. The no-load magnetic flux Ø₀ flows within the primary magnetic circuit and along a looped magnetic path defined by the magnetic circuit loop of the primary magnetic circuit. The looped magnetic path of the example FIG. 1A is defined by the geometry of the magnetic circuit portions and follows a substantially rectangular shape. When in the no-load condition, the primary magnetic circuit has an equivalent permeability of:

$${μ}_{eq} = \frac{{μ}_{L} {μ}_{H} ( 4 L + 2 H + {w}_{b} )}{2 L {μ}_{H} + 2 L {μ}_{L} + 2 H {μ}_{L} + {w}_{b} {μ}_{L}}$$

the magnetomotive force (mmf) is mmf=0.4πNIₘ, and the magnetic flux density is

$${B}_{0} = \frac{0.4 π {NI}_{m}}{4 L + 2 H + {w}_{b}} .$$

In example no-load conditions where an alternating power source in the form of a square wave voltage train is supplied to the power input of the primary magnetic circuit, the magnetizing current in the primary magnetic circuit is a triangular wave current train, as depicted in FIG. 1A2.

In example operations when the primary magnetic circuit 120 is under loaded operation conditions, for example, when a secondary magnetic circuit which is connected to a load is detachably attached to the primary magnetic circuit with alternating power input, as depicted in FIG. 2A, an output power carrying magnetic flux Ø₁ will flow from the primary magnetic circuit into the secondary magnetic circuit and then return into the primary magnetic circuit, a substantial portion of the magnetic flux will be diverted into the secondary magnetic circuit due to the substantially higher permeability (and therefore a substantially lower reluctance) of the secondary magnetic circuit which operates to shunt the magnetic flux into the secondary magnetic circuit. When in the loaded conditions, the magnetic flux moves along a path which deviates substantially from the looped magnetic path under no-load conditions which is solely defined by the circuit elements of the primary magnetic circuit.

The input voltage to the primary magnetic circuit is:

$${V}_{i n} = \frac{d ( {∅}_{1} + {∅}_{2} + {∅}_{3} )}{d t}$$

The output voltages are: Vₒ₁=n₁k₁Vᵢₙ and Vₒ₂=n₂k₂Vᵢₙ, where n₁, n₂ are secondary to primary turn ratio and k₁, k₂ are power coupling coefficients.

When the primary magnetic circuit 120 is in the loaded conditions of FIG. 2A, the load current Iᵢ which flows through the excitation windings will generate a total magnetic flux Øᵢₜ. A portion Ø₁ of the total magnetic flux will flow through the secondary magnetic circuit, a portion Ø₂ of the total magnetic flux will flow through the portion of the primary magnetic circuit shunted by the secondary magnetic circuit, and a remaining portion Ø₃ of the total magnetic flux will flow as a leakage flux into air, as depicted schematically in FIG. 2A1.

The secondary magnetic circuit may be attached to the primary magnetic circuit while the input excitation current is flowing through the primary excitation circuit 140 or when no excitation current flows through the primary excitation circuit 140.

When there is no excitation current flowing through the primary excitation circuit 140, a user will bring the secondary magnetic circuit very close to the primary magnetic circuit with the corresponding power input portions and power output portions aligned for magnetic flux tapping. When the secondary magnetic circuit is very close to the primary magnetic circuit herein, the airgap between the primary and the secondary magnetic circuits are negligible. After the primary and the secondary magnetic circuits are in close proximity and with the corresponding flux coupling portions aligned, the magnetic flux generated by the excitation current flowing through the primary excitation circuit will generate a magnetic attraction force to hold the primary and the secondary magnetic circuits in place and stationary with respect to each other.

In some embodiments, the airgap may be kept as short as possible by means of appropriate alignment techniques (e.g. US2016/0001669 and US2017/0259680).

When the primary magnetic circuit is under excitation, that is, an excitation current flows through the primary excitation circuit 140, while the primary is in a no-load condition, and when a secondary magnetic circuit is brought close to the flux coupling portions of the primary magnetic circuit, a small portion of the magnetic flux generated by the excitation current flowing through the primary excitation circuit will be diverted through the corresponding flux coupling portions which are in proximity and the magnetic force due to the initially weak diverted flux will operate to guide a user to bring the secondary magnetic circuit to move relative towards the primary magnetic circuit and bring them into auto-alignment or self-alignment, for example with the I-shaped portion 126. After the secondary magnetic circuit and the primary magnetic circuit have established magnetic field coupling and magnetic field communication, the input current will operate to maintain the primary and secondary magnetic circuits in detachable attachment by operational magnetic coupling during power transmission operations.

Furthermore, since the power tapping bar 162 is longer than the length of the separation distance between the adjacent high permeability portions which are separated by the I-shaped portion 126, and because the entire power tapping bar 162 is magnetically naked, the contact portion lengths of the two opposite longitudinal ends of the power tapping bar 162 may be equal. However, as the magnetic attraction force on the power tapping bar 162 is dependent on the contact portion lengths and would be maximum when the contact portion lengths are equal, a user can by slight movement of the power tapping bar 162 in the longitudinal direction locate a position of maximum attraction, which usually means a location where the contact portion lengths are equal.

An example power transmission apparatus 20 comprises a power input apparatus 100 of FIG. 1A and two power output apparatus, as depicted schematically in FIG. 2B. The example power transmission apparatus 20 is identical to the example power transmission apparatus 10 plus an additional second power output apparatus which is detachably attached to other output portions of the primary magnetic circuit. The two power output apparatuses are independently attachable to the primary magnetic circuit. The second power output apparatus is generally and substantially identical in structure to the power output apparatus of FIG. 2A and the description on and in relation to the power output apparatus of FIG. 2A is incorporated herein and to apply mutatis mutandis. The second power output apparatus comprises a power tapping bar 162B and a plurality of secondary windings 164B wound on the power tapping bar. The power tapping bar 162B is attached to the primary magnetic circuit such that a first longitudinal end of the power tapping bar 162B is in detachable attachment with a peripheral outer surface of the core portion 124 which is not in connect with the power tapping bar 162 and a second longitudinal end of the power bar 162B is in detachable attachment with the interior peripheral surface of the limb portion 122C that is opposite facing a longitudinal end of the core portion 124. During power transfer operations, output power carrying magnetic flux is shunted to the power tapping bar 162 and the power tapping bar 162B to transfer power to the two power output apparatuses. The number of secondary windings 164, 164B of the two power output apparatuses may be independently selected so that they can be same or different.

An example power transmission apparatus 30 comprises a power input apparatus 100 of FIG. 1A and a power output apparatus, as depicted schematically in FIG. 2C. The power transmission apparatus 30 is substantially identical to that of the power transmission apparatus 20 except that the two groups of secondary windings are wound on a common power tapping bar. In this example, the longitudinal ends of the power tapping bar are detachably attached to the ends surfaces of the two limb portions 122B and 122C of the primary magnetic circuit. In this example, the permeability of the power tapping bar 362 is substantially higher than the overall permeability of the linear core portion, a substantial portion of the power carrying magnetic flux is diverted into the power output apparatus and shunted away from the linear core portion.

In a variant of the primary magnetic circuit 120 of FIG. 1A, the linear core portion is replaced by free space such that the linear core portion has a relative permeability of one. In a variant of the primary magnetic circuit 120 of FIG. 1A, the linear core portion of the primary magnetic circuit comprises an elongate body of uniform permeability along its length and has a permeability substantially lower than the permeability of the higher permeability core portion and/or the permeability of the power tapping bar.

In example applications of the primary magnetic circuit 120 and its variants, the power tapping bar, instead to attaching to an end surface of the limb portion 122B, 122C, can be detachably attached to the peripheral surface of the limb portion(s) 122B, 122C that is between the inward facing and outward facing peripheral surfaces of the limb portions 122B, 122C. Since the limb portions 122B, and 122C are magnetically naked or unshielded, the power tapping bar of a power output apparatus can slide along the length of the limb portions 122B, 122C to tap power without interruption. Furthermore, since the limb portions 122B, and 122C are magnetically naked or unshielded, power tapping bar can be attached to any selected location on the first limb portion 122B, and any selected location on the second limb portion 122C to tap power and such a possibility provides substantial convenience and flexibility.

An example power transmission apparatus 40 comprises a power input apparatus and a power output apparatus, as depicted schematically in FIG. 2D. The power input apparatus comprises a primary magnetic circuit 220 which has a substantially identical structure and arrange as that of FIG. 1A, except that the linear core portion comprises a plurality of hybrid core portions 124A, 124B, 124C in series connection. The description on and in relation to the input apparatus of FIG. 1A is incorporated herein by way of reference. Each hybrid core portion comprises a high permeability core portion and a low permeability core portion which is longitudinally aligned and series connected. The plurality of hybrid core portions forming the linear core portion provides a plurality of more than three output portions to facilitate more flexible selection or combination of selection of flux coupling portions without loss of generality. Note that the magnetic flux in the magnetic core of the power input apparatus is not reduced even if any additional high permeability core portions or low permeability core portions are inserted. However, when the magnetic core is long, the pickup energy received by power receiving unit is reduced because the core loss and the leakage to air increase.

An example power transmission apparatus 50 comprises a power input apparatus 500 as depicted schematically in FIG. 2E. The power input apparatus 500 comprises a magnetic core where the magnetic core is formed by end-to-end connecting a single high permeability core portion 422 to a single low permeability core portion 426 to form a loop. The high permeability core portion 422 comprises two connecting surfaces 423a, 423b. The low permeability core portion 426 connects to the first connecting surface 423a and the second connecting surface 423b of the high permeability core portion 422. In some embodiments, the low permeability core portion 426 is an I-shaped core portion with one longitudinal end connecting to the first connecting surface 423a and the other longitudinal end connecting to the second connecting surface 423b.

An example power transmission apparatus 60 comprises a power input apparatus and a power output apparatus, as depicted schematically in FIG. 2F. The power transmission apparatus 60 comprises a plurality of power transmission apparatuses 40 connected in parallel and the description on and in relation to the power transmission apparatuses 40 is incorporated herein by way of reference.

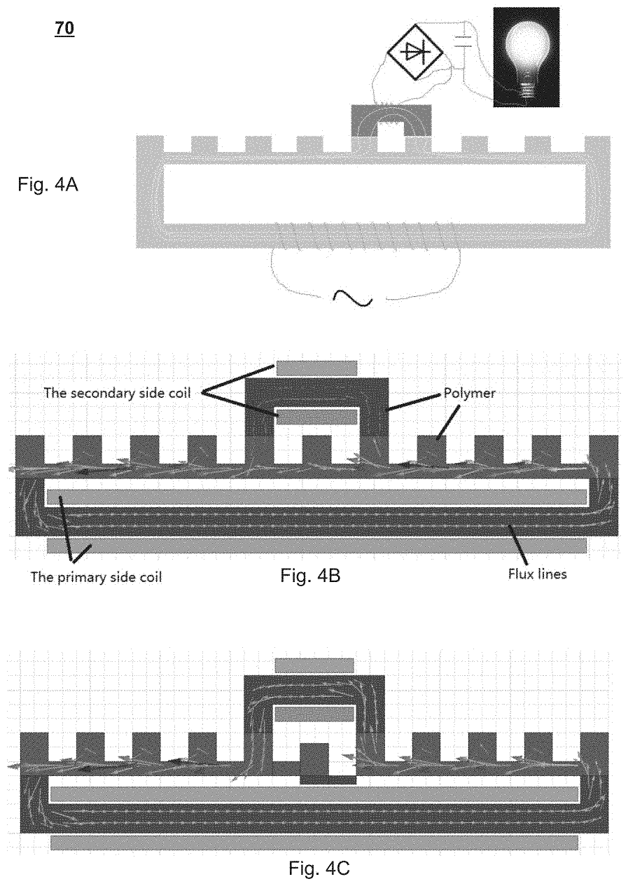

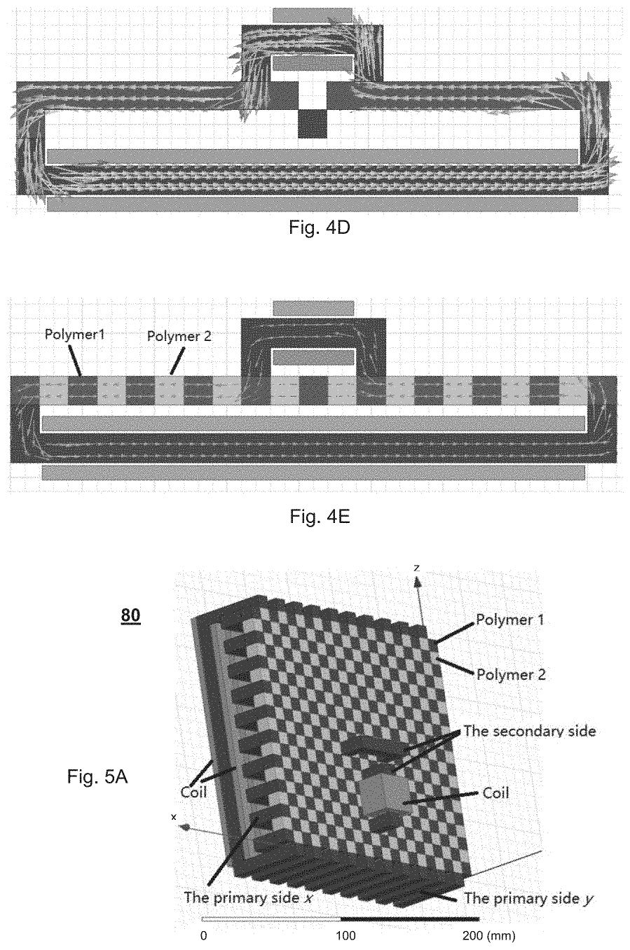

An example power transmission apparatus 70 comprises a power input apparatus and a power output apparatus, as depicted schematically in FIG. 4A. The power input apparatus of the power transmission apparatus 70 has a basic C-shaped core portion that is substantially identical to that of the primary magnetic circuit 120. However, the core portion which interconnects the limb portions and which is parallel to the base portion is different. Referring to FIG. 4A, the core portion which interconnects the limb portions is a bridging portion and the bridging portion comprises an elongate body having a uniform and high permeability along its length which extends between the two limb portions. The bridging portion comprises a core bar and a plurality of power coupling portions. The core bar extends along a longitudinal axis and comprises a first longitudinal end, a second longitudinal end and an outer peripheral surface interconnecting the first and second longitudinal ends. The power coupling portions are distributed along the length of the core bar and each power coupling portion has a flux passage surface which is parallel to the longitudinal axis and is displaced from the outer peripheral surface. Each power coupling portion is a protrusion which extends in a direction orthogonal to the longitudinal axis and projects away from the outer peripheral surface. The ensemble of power coupling portions appears as an array of teeth portions projecting from the core bar, as depicted in FIG. 4A. The no-load magnetic flux is confined within the outer peripheral surface of the core bar; and the power coupling portions and their flux passage surfaces are outside the no-load magnetic flux loop path of the primary magnetic circuit.

During power transmission operations, magnetic flux moves along a first looped flux path which is confined within the primary magnetic circuit and a first looped flux path which passes through the power tapping bar, as depicted in FIG. 4B. FIGS. 4C to 4E show magnetic flux paths of several variant of the primary magnetic circuit of FIG. 4A. In the variant of FIG. 4E, the linear core portion comprises a plurality of high permeability core portions and a plurality of low permeability core portions such that adjacent high permeability core portions are separated by a low permeability core portions and adjacent low permeability core portions are separated by a high permeability core portions. In other words, the linear core portion comprises alternately disposed high and low permeability core portions and the free surfaces of the high and low permeability core portions are flush to define a flux coupling plane.

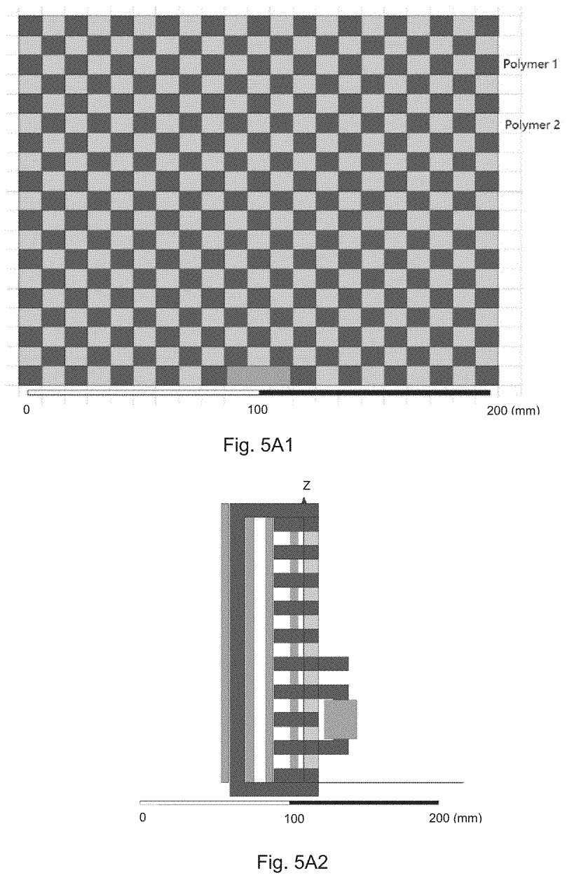

An example power transmission apparatus 80 comprises a power input apparatus and a power output apparatus, as depicted schematically in FIGS. 5A, 5A1 and 5A2. The power input apparatus comprises an ensemble of primary magnetic circuits of FIG. 4E and end surfaces of the high and low permeability core portions are alternately disposed to form a main power coupling plane resembling a checker board, as depicted in FIG. 5A1. A power output apparatus can elect to attach to the any pair of flux coupling surfaces to tap power. Since the end surfaces of the high and low permeability core portions are flush, the power coupling surfaces of the power output apparatus can slide on the main power coupling plane and to tap power at a selected power tapping location among a plurality of available power tapping locations. In some embodiments, the free end surface of the low permeability core portions is retracted below the free end or flux passage surface, of the high permeability core portions to facilitate convenient power tapping.

While the disclosure has been made with reference to example embodiments, it should be appreciated that the embodiments serve as examples and shall not be construed as imposing restriction on the scope of disclosure. For example, while the primary magnetic circuits herein are in a C-shape, it should be appreciated that the shape is only an example to facilitate formation of a first looped magnetic circuit under no-load condition plus formation of a secondary looped magnetic circuit in cooperation with a secondary magnetic circuit during power transmission operations. For example, the shape of the magnetic core portions forming the primary magnetic circuit can be square, circular or of another shape provided that such shape can conduct magnetic flux.

Usually, a wire used in forming the excitation windings and/or the secondary windings is made of copper. Other conductor may also be used for the wire.

The number of turns of the excitation winding may be selected according to an output power intended to be delivered to the load 168. The higher the current in the excitation windings and the higher the number of turns, the higher the magnetic flux that is generated so as to provide a higher output power.

In example applications, the flux passage surfaces of the primary magnetic circuit are distributed on or behind a non-magnetic wall or a non-magnetic partition to function as power outlet portions. The power outlet portions may be arranged in a matrix or array form to facilitate flexible power tapping. For example, a plurality of tens or hundreds of power outlet portions can be provided on a single wall of a domestic premises. Since adjacent power outlets separated by a lower permeability interconnection or separation portion can form a pair of power tapping outlets, many pairs of power tapping outlets can be selected by a user to enhance power tapping flexibility and convenience.

While a secondary magnetic circuit herein is to tap power from a primary magnetic circuit upon detachable attachment, it should be understood that the detachable attachment includes detachable attachment in abutment contact and non-abutment contact, for example, detachable attachment with a small separation distance, such as an airgap or a small thickness of a covering material without loss of generality.

In performing WPT by positioning the power tapping bar 162 to overlie the I-shaped low permeability portion 126 and to partially overlap the two high permeability core portions (the first limb portion 122B the I-shaped connection portion 124) on the primary magnetic circuit, the low permeability portion 126 maybe separated from the power tapping bar 162 by the airgap of length between 0.05 mm to 3 mm, or of length within 0.1% to 10% of a length of the power tapping bar 162. The minimum airgap can be very small if the gap between the power input apparatus 100 and the power tapping bar 162 or the secondary magnetic circuit 160B and power input apparatus 100 are in touch.

In some embodiments, an AC power source is used to supply a high frequency signal to excite the excitation windings to thereby generate the magnetic flux in the magnetic core. The working frequency of the AC power source can be set to 20 kHz or above to ensure that the working frequency is beyond the normal audible range of human beings. The signal can be a sine wave or a square wave, or any other AC signal considered appropriate for practical situation by those skilled in the art. In case of using the square wave, it may be generated by a power electronics switching circuit. The duty cycle of the square wave can be set to be 50% for avoiding saturation of the magnetic core portions. The square wave can be modified into a more sinusoidal wave by inserting appropriate resonant circuit such as inductor and capacitor. This is known as the resonant excitation from square wave to sinusoidal wave to a transformer/coil.

Table of numerals

| | | | |
|---|---|---|---|
| 100 | Power input apparatus | | |
| 120 | Primary magnetic circuit | 140 | Primary excitation circuit |
| 122 | C-shaped core portion | 142 | Excitation windings |
| 122A | Elongate base portion | | |
| 122B | First (left) limb portion | | |
| 122C | second (right) limb portion | 160 | Secondary magnetic circuit |
| 124 | I-shaped connection portion | 162 | Power tapping bar |
| 126 | First (left) bridging portion | 164 | Secondary windings |
| 128 | Second (right) bridging | 168 | Load |
| | portion | | |

1-27. (canceled)

28. A power transmission apparatus comprising a primary magnetic circuit, a primary excitation circuit which is configured for connection to an alternating power source to supply input power to the primary magnetic circuit, and a secondary magnetic circuit for supplying output power to a load;
wherein the primary magnetic circuit comprises a plurality of high permeability circuit portions and at least a flux coupling portion on the high permeability circuit portion,
wherein two adjacent high permeability circuit portions are interconnected by a low permeability circuit portion; and
wherein the secondary magnetic circuit comprises a high permeability circuit portion which is coupled to the flux coupling portion of the primary magnetic circuit as a shunting branch to facilitate coupling of magnetic power from the primary magnetic circuit to the secondary magnetic circuit for power output during power transmission operations.

29. The power transmission apparatus of claim 28, wherein the plurality of high permeability circuit portions and the low permeability circuit portion or a plurality of low permeability circuit portions interconnecting adjacent high permeability circuit portions cooperate to form a first magnetic circuit defining a first magnetic path, wherein the first magnetic circuit is a looped magnetic circuit and the first magnetic path is a looped magnetic path; and wherein the shunting branch of the secondary magnetic circuit is outside the first magnetic path.

30. The power transmission apparatus of claim 29, wherein the primary excitation circuit is configured to generate a primary magnetic flux to flow in the high permeability circuit portions of the primary magnetic circuit, wherein the secondary magnetic circuit is configured so that a secondary magnetic flux is to flow from a flux exit surface of the primary magnetic circuit into a flux entry surface of the secondary magnetic circuit during power transmission operations, and wherein the flux entry surface is outside the first magnetic path.

31. The power transmission apparatus of claim 29, wherein the primary excitation circuit is configured to generate a primary magnetic flux to flow in the high permeability circuit portions of the primary magnetic circuit, wherein the secondary magnetic circuit is configured so that a secondary magnetic flux is to flow from a flux exit surface of the primary magnetic circuit into a flux entry surface of the secondary magnetic circuit during power transmission operations, and wherein the high permeability circuit portion of the secondary magnetic circuit is outside the first magnetic path.

32. The power transmission apparatus of claim 29, wherein the flux coupling portion is defined on a portion of the high permeability circuit portion of the primary magnetic circuit, and the flux coupling portion is on a peripheral surface which is outside the first magnetic path.

33. The power transmission apparatus of claim 29, wherein the secondary magnetic circuit cooperates with the primary magnetic circuit to form a second magnetic circuit defining a second magnetic path, and wherein the second magnetic circuit is a looped magnetic circuit and the second magnetic path is a looped magnetic path.

34. The power transmission apparatus of claim 28, wherein the secondary magnetic circuit is detachably attached to the primary magnetic circuit and is attracted to the primary magnetic circuit by magnetic coupling force during power transmission operations.

35. The power transmission apparatus of claim 28, wherein the primary magnetic circuit and the secondary magnetic circuit are physically separated by a magnetic permeable partition.

36. The power transmission apparatus of claim 28, wherein the second magnetic circuit comprises a flux tapping portion which is configured to tap magnetic power from the flux coupling portion of the primary circuit, and wherein the flux tapping portion is on an end of the high permeability circuit portion of the second magnetic circuit.

37. The power transmission apparatus of claim 28, wherein the primary magnetic circuit comprises a plurality of flux coupling portions and the secondary magnetic circuit comprises a corresponding plurality of flux tapping portions which is configured to tap power from the plurality of flux coupling portions.

38. The power transmission apparatus of claim 28, wherein the high permeability circuit portion comprises a magnetic polymer or is filled with a magnetic filler.

39. The power transmission apparatus of claim 28, wherein the high permeability circuit portion has a relative permeability of 400 or more, including 400, 500, 600, 1 k, 2 k, 3 k, 4 k, 5 k or more, or a range or ranges formed by combining any of the aforesaid values.

40. The power transmission apparatus of claim 28, wherein the low permeability circuit portion has a relative permeability of 500 or less, including 400, 300, 200, 100, 50, 30, 20, 10, 1, or less, or a range or ranges formed by combining any of the aforesaid values.

41. The power transmission apparatus of claim 28, wherein the primary magnetic circuit comprises a plurality of flux coupling portions and each flux coupling portion has a power coupling surface, and wherein the power coupling surfaces of the plurality of flux coupling portions cooperate to define a power coupling plane.

42. The power transmission apparatus of claim 41, wherein the power coupling surfaces of the plurality of flux coupling portions are arranged to form a matrix of power outlet portions.

43. The power transmission apparatus of claim 41, wherein the primary magnetic circuit comprises a main high permeability portion having a first end and a second end, and a plurality of discrete high permeability members distributed between the first end and the second end; wherein the discrete high permeability members are connected in series in a first direction; and wherein two adjacent discrete high permeability members are interconnected by a low permeability circuit portion.

44. The power transmission apparatus of claim 43, wherein each discrete high permeability member has a power coupling surface which is parallel to the first direction.

45. The power transmission apparatus of claim 44, wherein the power coupling surfaces of the discrete high permeability members of the primary magnetic circuit cooperate to define a power coupling plane.

46. The power transmission apparatus of claim 44, wherein the discrete high permeability members are organised into a plurality of rows, and adjacent discrete high permeability members in a row have a uniform spacing.

47. The power transmission apparatus of claim 44, wherein each discrete high permeability member is configured as a column having a column axis orthogonal to the first direction, and the discrete high permeability members are held together by a low permeability polymer.
